(19) United States
(12) Patent Application Publication
(10) Pub. No.: US 2004/0130762 A1
(43) Pub. Date: Jul. 8, 2004

(54) Optical acquisition systems for direct-to-digital holography and holovision

(76) Inventors: Clarence E. Thomas, Knoxville, TN (US); Michael W. Mayo, Austin, TX (US); Ian McMackin, Austin, TX (US); Kenneth R. MacDonald, Bozeman, MT (US); Gregory R. Hanson, Clinton, TN (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/661,175

(22) Filed: Sep. 12, 2003

Related U.S. Application Data
(60) Provisional application No. 60/410,151, filed on Sep. 12, 2002.

(51) Int. Cl. G02B 5/32

(52) U.S. Cl. 359/15

(57) ABSTRACT

Optical acquisition systems for direct-to-digital holography are disclosed. The system includes an illumination lens for focusing a reference beam and a beam splitter optically coupled to the illumination lens by the reference beam. A reference mirror is located at a waist of the reference beam and operates to eliminate a reference objective.

### CROSS REFERENCE TO RELATED APPLICATION

This application claims priority from U.S. Provisional Patent Application Serial No. 60/410,151, filed Sep. 12, 2002 by Clarence E. Thomas, et al., and entitled “Four Optics Improvements to Optical Direct to Digital Holography System.”

### GOVERNMENT LICENSE RIGHTS

The U.S. Government has a paid-up license in this invention and the right in certain circumstances to require the patent owner to license others on reasonable terms as provided for by the terms of Contract No. DE-AC050R22725 for the U.S. Department of Energy.

### TECHNICAL FIELD OF THE INVENTION

This invention relates in general to the field of image processing and, more particularly, to optical acquisition systems for direct-to-digital holography and holovision.

### BACKGROUND OF THE INVENTION

In a direct-to-digital to holographic system, holograms from highly similar objects can be obtained. Consecutive processing of the holograms allows comparison of actual image waves of the objects. These image waves contain significantly more information for the small details of the objects than conventional non-holographic images, because image phase information is retained in the holograms, but lost in conventional images.

Some holography systems may include a reference arm for generating a reference beam and a target arm for generating a target beam. The reference and target beams may be combined in order to produce a complex image that is captured by a digital recorder, such as a high resolution charge coupled device (CCD) camera. In order to produce the image, the zero order waves associated with the reference and target beams should be matched. Conventional systems match each of the beams by providing identical optics in each of the arms. The optics used in these systems, however, may be expensive and may increase the overall cost of the systems.

A holography system may also require that the power in the reference and target arms be matched. In conventional systems, a half-wave plate may be placed before a beam splitter that divides a beam provided by a laser into a reference beam associated with the reference arm and a target beam associated with the target arm. A rotatable half-wave plate may then be added to one of the arms in order match the polarization in that arm with the polarization in the other arm such that the reference and target beams at the camera have the same polarization. This configuration, however, has a disadvantage for holographic systems using polarizing components later in the system (e.g., an Acousto-Optic Modulator (AOM) or Polarizing Beam Splitter (PBS), or other polarization sensitive components) in that the polarization may not be well-matched to the system.

In a conventional system, illumination lenses in each of the reference and target arms may be used to focus the respective reference and target beams. If the beams are collimated, the beams are typically focused at the center of the field of view for the objectives. The illumination lens, therefore, captures the lower frequency components contained in the on-axis, incident light, which provides intensity information for the image. The higher frequencies included in the off-axis, diffracted light may not be captured by the illumination lens, which may affect the resolution of the image.

Beam splitters that may be used in many holography systems are common optical components that partially transmit and partially reflect an incident beam. One common type of beam splitter is a plate beam splitter. In general, a metallic or dielectric film may be deposited on a surface facing the incident illumination while an antireflective coating may be applied to a back surface that is parallel to the front surface. When incident light strikes the first surface of the beam splitter, part of the beam is reflected and the remainder of the beam is transmitted. The transmitted portion of the beam may strike the back surface of the beam splitter. Although the antireflective coating may prevent a large portion of the transmitted beam from being reflected back towards the front surface, some of the transmitted beam will be reflected in the direction of beam reflected from the first surface. This reflection may create a ghost image that causes interference patterns such as lines and circles to be present in the image formed at the camera.

### SUMMARY OF THE INVENTION

In accordance with the teachings of the present invention, disadvantages and problems associated with optical acquisition systems for direct-to-digital holography have been substantially reduced or eliminated. In a particular embodiment, a direct-to-digital holography system includes a tilting mirror located at a back focal point of an illumination lens and operable to pivot in order to reflect a laser beam toward the lens at an off axis angle.

In accordance with one embodiment of the present invention, a direct-to-digital holography system includes an illumination lens for focusing a reference beam and a beam splitter optically coupled to the illumination lens by the reference beam. A reference mirror is located at a waist of the reference beam and operates to eliminate a reference objective.

In accordance with another embodiment of the present invention, a method for acquiring a complex image in a direct-to-digital holography system includes focusing a reference beam having a waist with an illumination lens, the reference beam including a waist and transmitting at least a portion of the reference beam through a beam splitter. A portion of the reference beam is reflected from a reference mirror located at the waist of the reference beam.

In accordance with a further embodiment of the present invention, a direct-to-digital holography system includes a laser for producing a laser beam and a half-wave plate optically coupled to the laser. The half-wave plate rotates the laser beam between a first polarization and a second polarization. A beam splitter is located proximate the half-wave plate and splits the laser beam into a reference beam associated with a reference arm and a target beam associated with a target arm such that the reference beam includes the first polarization and the target beam includes the second polarization. A target half-wave plate is optically coupled to the beam splitter by the target beam and a reference half-wave plate is optically coupled to the beam splitter by the reference beam. The target and reference half-wave plates operate to respectively rotate the target and reference beams in order to match polarizations of the target and reference arms.

In accordance with an additional embodiment of a present invention, a method for acquiring a complex image in a direct-to-digital holography system includes rotating a laser beam such that the laser beam includes either a first polarization or a second polarization and splitting the rotated beam into a target beam associated with a target arm and a reference beam associated with a reference arm such that the target beam includes the first polarization and the reference beam includes the second polarization. Either the target beam or the reference beam is rotated in order to obtain either the first polarization or the second polarization at beam combiner located proximate outputs of the target and reference arms.

In accordance with yet another embodiment of the present invention, a direct-to-digital holography system includes a laser for generating a laser beam and a lens for focusing the laser beam. A tilting mirror is optically coupled between the laser and the lens at a back focus point of the lens. The tilting mirror pivots in order to reflect the laser beam towards the lens at an off-axis angle.

In accordance with yet a further embodiment of the present invention, a method for acquiring a complex image in a direct-to-digital holography system includes reflecting a laser beam from a tilting mirror that pivots about a center in order to create an off-axis laser beam and is located at a back focal point of an illumination lens. The off-axis laser beam is passed through the illumination lens and a target is illuminated with the off-axis laser beam in order to generate an image including high frequency components.

In accordance with an additional embodiment of the present invention, a direct-to-digital holography system includes a laser for generating a laser beam and a cube beam splitter that eliminates first order reflections optically coupled to the laser.

Important technical advantages of certain embodiments of the present invention include a direct-to-digital holography system that has an improved resolution. Spatial information associated with a complex image is generally located in the higher frequency components of a beam. By placing a tilting mirror at a back focal point of a target illumination lens, the angle of the target beam illuminating a target may be varied such that a target objective captures off-axis light.

Another important technical advantage of certain embodiments of the present invention includes a direct-to digital holography system that reduces ghost images generated by back reflections from a beam splitter. Generally, a plate beam splitter includes an anti-reflective (AR) coating on the back surface of the plate that prevents most reflections. However, some light is typically reflected off the back surface and travels in the same direction as a beam reflected off the front surface of the plate. This reflection may be a first order reflection because ghost beam only reflects from one surface of the plate. The present invention reduces ghost images by providing a cube beam splitter that only produces second order reflections because the ghost beam must be reflected from at least two surfaces of the cube before it travels in the same direction as the desired wave.

All, some, or none of these technical advantages may be present in various embodiments of the present invention. Other technical advantages will be readily apparent to one skilled in the art from the following figures, descriptions, and claims.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 illustrates a schematic view of a direct-to-digital holography system in accordance with teachings of the present invention;

FIG. 2 illustrates a schematic view of another direct-to-digital holography system in accordance with teachings of the present invention;

FIG. 3 illustrates a schematic view of a reference arm included in a direct-to-digital holography system in accordance with teachings of the present invention;

FIG. 4 illustrates a schematic view of a laser beam split into two orthogonally polarized beams in accordance with teachings of the present invention;

FIG. 5 illustrates a schematic view of a target arm included in a direct-to-digital holography system in accordance with teachings of the present invention;

FIG. 6 illustrates a schematic view of a plate beam splitter included in a direct-to-digital holography system; and

FIG. 7 illustrates a schematic view of a cube beam splitter included in a direct-to-digital holography system in accordance with teachings of the present invention.

### DETAILED DESCRIPTION

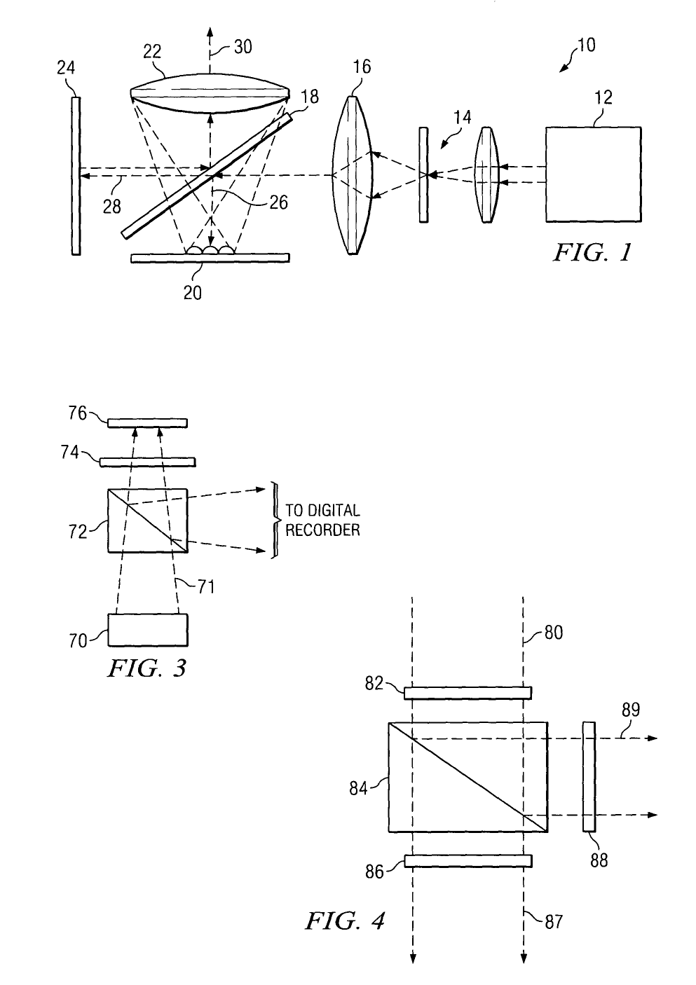

Preferred embodiments of the present invention and their advantages are best understood by reference to FIGS. 1 through 6, where like numbers are used to indicate like and corresponding parts.

The following invention generally relates to digital holographic imaging systems and applications as described in U.S. Pat. No. 6,078,392 entitled Direct-to-Digital Holography and Holovision, U.S. Pat. No. 6,525,821 entitled, Acquisition and Replay Systems for Direct to Digital Holography and Holovision, U.S. patent application Ser. No. 09/949,266 entitled System and Method for Correlated Noise Removal in Complex Imaging Systems, now U.S. Pat. No. ______, and U.S. patent application Ser. No. 09/949,423 entitled, System and Method for Registering Complex Images, now U.S. Pat. No. ______, all of which are incorporated herein by reference.

FIG. 1 illustrates a schematic view of direct-to-digital holography system 10. System 10 includes laser 12, beam expander/spatial filter 14, illumination lens 16, beam splitter 18, target 20, focusing lens 22 and mirror 24. In the illustrated embodiment, laser 12 directs a beam of light toward expander/filter 14 and the expanded/filtered light travels through illumination lens 16 to beam splitter 18. Beam splitter 18 may be any optical element that transmits a first percentage and reflects a second percentage of the beam generated by laser 12. In one embodiment, beam splitter 18 may be a 50/50 beam splitter where approximately fifty percent (50%) of a beam is reflected and approximately fifty percent (50%) of the beam is transmitted. In other embodiments, beam splitter 18 may reflect and/or transmit any suitable percentage of light. Beam splitter 18 may include, but is not limited to, a cube beam splitter and a plate beam splitter.

The expanded/filtered light that is reflected by the beam splitter constitutes target beam 26 which travels toward target 20. In one embodiment, target 20 may be an electronic device fabricated from silicon, germanium or any compound containing group III and/or group V elements. In another embodiment, target 20 may be a photomask or reticle that includes a pattern formed on a substrate. In other embodiments, target 20 may be any other object, assembly or component from which a complex image may be generated. A portion of the light reflected from target 20 then passes through beam splitter 18 and travels toward focusing lens 22. Focusing lens 22 may operate to focus target 20 into the focal plane of a digital recorder (not expressly shown). Focusing lens 22 may further provide magnification or demagnification, as desired, by using lenses of different focal length and adjusting the corresponding spatial geometry (e.g., ratio of object distance to image distance). The focused light then travels to the digital recorder. In one embodiment, the digital recorder may be a high resolution charge coupled device (CCD) camera that may record and playback a hologram acquired from target 20. The digital recorder may further be interfaced with a computer (not expressly shown) that includes processing resources. In one embodiment, the processing resources may be one or a combination of a microprocessor, a microcontroller, a digital signal processor (DSP) or any other digital circuitry configured to process information.

The portion of the light from illumination lens 16 that is transmitted through beam splitter 18 constitutes reference beam 28. Reference beam 28 is reflected from reference mirror 24 at a small angle. The reflected reference beam from reference mirror 24 then travels toward beam splitter 18. The portion of the reflected reference beam that is reflected by beam splitter 18 then travels toward focusing lens 22. The reference beam from focusing lens 22 then travels toward the digital recorder. Together, the target beam and reference beam from focusing lens 22 constitute a plurality of simultaneous reference and object waves 30 that form a hologram.

System 10 may use a “Michelson” geometry (e.g., the geometrical relationship of beam splitter 18, reference beam mirror 24, and the digital recorder resembles a Michelson interferometer geometry). This geometry allows the reference beam and the target beam at focusing lens 22 to be combined at a very small angle. For example, reference mirror 24 may be tilted to create the small angle that makes the spatially heterodyne or sideband fringes for Fourier analysis of the hologram.

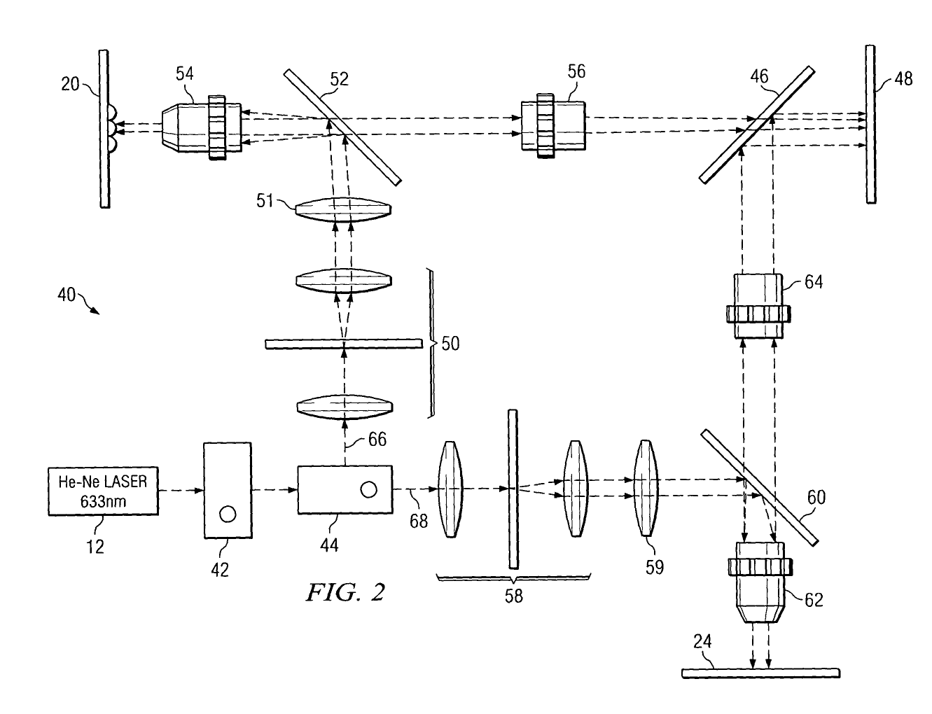

FIG. 2 illustrates a schematic view of another example embodiment of direct-to-digital holography system 40. System 40 includes laser 12, variable attenuator 42, variable beam splitter 44, a target arm, a reference arm, beam combiner 46 and digital recorder 48. The target arm may include target beam expander 50, target illumination lens 51, target beam splitter 52, target objective 54, target 20 and target tube lens 56. The reference arm may include reference beam expander 58, reference illumination lens 59, reference beam splitter 60, reference objective 62, reference mirror 24 and reference tube lens 64. In the illustrated embodiment, laser 12 directs a beam of light toward variable attenuator 42 and the attenuated light travels to variable beam splitter 44. Variable beam splitter 44 may be an optical element that transmits a portion of the beam and reflects another portion of the beam. In the illustrated embodiment, variable beam splitter 44 splits the beam of light into target beam 66 and reference beam 68.

Still referring to FIG. 2, target beam 66 is directed through target beam expander 50 toward target illumination lens 51 and into target beam splitter 52, which reflects a portion of target beam 66 toward target objective 54. The reflected target beam then interacts with target 20 and passes back through target objective 54. Target beam splitter 52 transmits the portion of the reflected target beam received from target objective 54 to beam combiner 46 via target tube lens 56. In the reference arm, reference beam 68 from variable beam splitter 44 passes through reference beam expander 58 toward reference illumination lens 59 and is reflected by reference beam splitter 60. The reflected portion of reference beam 68 passes through reference objective 62 and is reflected by reference mirror 24. The reflected reference beam then passes back through reference objective 62 and is transmitted by reference beam splitter 60. Reference tube lens 64 directs the beam toward beam combiner 46, which combines the beams from the target arm and the reference arm and directs the combined beams to digital recorder 48. In one embodiment, the combined beams may be digital data that be recorded, transmitted and/or transformed by a digital recorder (e.g., a CCD camera).

System 40 may use a Mach-Zender geometry. Comparing the Mach-Zender geometry of FIG. 2 (called Mach-Zender because of its similarity to the geometry of a Mach-Zender interferometer) with the Michelson geometry (as illustrated in FIG. 1), it can be appreciated that the focusing lens (e.g., target objective 54 in FIG. 2) can be much closer to target 20 because through-the-lens illumination allows target beam splitter 52 to be behind target objective 54 rather than between target objective 54 and target 20. This allows large numerical aperture, high magnification objectives to be used to look at (and record holograms of) small objects. For large objects the original Michelson geometry as illustrated in FIG. 1 may be preferable, depending on the situation.

It can also be appreciated from FIG. 2 that beam combiner 46 may be located close to digital recorder 48. Beam combiner 46 may combine reference beam 66 and target beam 68 to illuminate digital recorder 48. The angle of beam combiner 46 may be varied so that the reference and target beams are exactly co-linear, or in general strike digital recorder 48 at an angle to one another so that the heterodyne carrier fringes are produced. This allows the carrier fringe frequency to be varied from zero to the Nyquist limit of digital recorder 48. Beam combiner 46 may be closer to digital recorder 48 than with the Michelson geometry, at least for magnifying geometries (e.g., geometries where the object hologram is being magnified for acquisition by the digital camera). This allows the combining angle between the object and reference beams to be relatively large without causing the spots from the reference and target beams to no longer overlap at digital recorder 48. This allows much finer control over the carrier frequency fringes. In fact, it may be possible to vary the angle between the two beams from zero up to the maximum angle allowed by the constraints of the system without the spatial carrier frequency of the heterodyne hologram exceeding the Nyquist frequency allowed by the digital recorder (e.g., the angle can be increased until there are only two pixels per fringe of the spatial carrier frequency—beyond this angle the spatial carrier frequency is no longer correctly recorded by the digital recorder). With the Michelson geometry, the maximum spatial carrier frequency of the hologram may not be reachable because the angle required may be large enough that the reference and target beams would no longer overlap at the digital recorder for some geometries.

In operation, systems 10 and 40 may be suitable for recording and replaying holographic images in real time or storing them for replay later. A series of digitally stored holograms may be made to create a holographic motion picture or the holograms can be broadcast electronically for replay at a remote site to provide holographic television (HoloVision). Since a hologram stores amplitude and phase, with phase being directly proportional to wavelength and optical path length, direct-to-digital holography systems 10 and 40 may also serve as extremely precise measurement tools for verifying shapes and dimensions of precision components, assemblies, etc. Similarly, the ability to store the holograms digitally immediately provides a method for digital holographic interferometry. Holograms of the same object, after some physical change (stress, temperature, micromachining, etc.), may be subtracted from one another (direct subtraction of phase) to calculate a physical measurement of the change, where the phase change is directly proportional to wavelength. Similarly one object can be compared to a like object to measure the deviations of the second object from the first or master object, by subtracting the respective holograms. To unambiguously measure phase changes greater than 2π in the z-plane over two pixels in the x-y plane, holograms should be recorded at more than one wavelength.

Systems 10 and 40 combine the use of high resolution digital recorders, such as video cameras, very small angle mixing of the holographic object and reference waves (e.g., mixing at an angle that results in at least two pixels per fringe and at least two fringes per spatial feature to be resolved), imaging of the object at the recording (camera) plane, and Fourier transform analysis of the spatially low-frequency heterodyne (side-band) hologram to make it possible to record holographic images (e.g., images with both the phase and amplitude recorded for every pixel). Additionally, an aperture stop may be used in the back focal plane of one or more lenses involved in focusing the object to prevent aliasing of any frequencies higher than can be resolved by the imaging system. No aperture is necessary if all spatial frequencies in the object are resolvable by the imaging system.

Once recorded, it is possible to either replay the holographic images as 3-D phase or amplitude plots on a two-dimensional display or to replay the complete original recorded wave using a phase change crystal and white light or laser light to replay the original image. The original image is replayed by writing it in the phase-change medium with lasers, and either white light or another laser is used to replay it. By recording an image with three different colors of laser and combining the replayed images, it is possible to make a true-color hologram. By continuously writing and replaying a series of images, it is possible to form holographic motion pictures. Since these images are digitally recorded, they can also be broadcast with radio frequency (RF) waves (e.g., microwave) or over a digital network of fibers or cables using suitable digital encoding technology, and replayed at a remote site. This effectively allows holographic television and motion pictures or “HoloVision.”

Systems 10 and 40 may also be embodied in a number of alternative approaches. For instance, systems 10 and 40 may use phase shifting rather than heterodyne acquisition of the hologram phase and amplitude for each pixel. In another embodiment, systems 10 and 40 may use numerous different methods of writing the intensity pattern to an optically sensitive crystal. These include using a sharply focused scanning laser beam (rather than using a spatial light modulator), writing with an SLM but without the biasing laser beam, and many possible geometric variations of the writing scheme. In an additional embodiment, systems 10 and 40 may use optically sensitive crystals employing optical effects other than phase change to create the diffraction grating to replay the hologram. In a further embodiment, systems 10 and 40 may use a very fine-pixeled SLM to create the intensity pattern, thereby obviating any need to write the intensity pattern to an optically active crystal for replaying the hologram.

FIG. 3 illustrates a schematic view of a reference arm included in a direct-to-digital holography system. The reference arm may include illumination lens 70, beam splitter 72, quarter-wave plate 74 and reference mirror 76. A beam of light generated by a laser, such as laser 12 as shown in FIGS. 1 and 2, may be directed toward illumination lens 70, which directs reference beam 71 toward beam splitter 72. In one embodiment, the laser beam may be a Gaussian beam. Beam splitter 72 may partially transmit and partially reflect reference beam 71. In the illustrated embodiment, beam splitter 72 may be a polarizing beam splitter cube. In other embodiments, beam splitter 72 may be a plate beam splitter. The portion of reference beam 71 transmitted through beam splitter 72 may be rotated a quarter wavelength (e.g., approximately ninety degrees in phase) by quarter-wave plate 74. The rotated beam may then be reflected by reference mirror 76.

The beam reflected by reference mirror 76 may pass through quarter-wave plate 74 and be rotated another quarter wavelength such that the reflected reference beam has the opposite polarization of the portion of reference beam 71 transmitted through beam splitter 72. For example, if the transmitted reference beam is p-polarized, the reflected reference beam received at beam splitter 72 from quarter-wave plate 74 may be s-polarized. In this example, beam splitter 72 transmits p-polarized light and reflects s-polarized light. In other embodiments, beam splitter 72 may transmit s-polarized light and reflect p-polarized light. The reflected reference beam composed of s-polarized light, therefore, will be reflected toward a digital recorder, such as digital recorder 48 as shown in FIG. 2.

As illustrated in FIG. 2, the reference arm of system 40 may include reference objective 62 and the target arm may include target objective 54. In some embodiments, reference objective 62 and target objective 50 may be similar such that the zero-order wavefronts of target beam 66 and reference beam 68 are matched in order to obtain linear fringes at digital recorder 48. However, objectives may be expensive and thus, increase the cost of system 40. As described in U.S. Pat. No. 6,525,821, it is not necessary to have exactly identical optics in the reference and target arms in order to match the two zero-order (unscattered by a target) wavefronts at digital recorder 48.

Referring now to FIG. 3, a reference objective may be eliminated and the optical symmetry of the reference arm and the target arm may be retained by placing reference mirror 76 at the waist of reference beam 71 formed by illumination lens 70. Since target objective 54 in system 40 (as illustrated in FIG. 2) may be designed to form a waist (e.g., a point at which the beam of light has the smallest diameter and a flat wavefront) at target 20, the zero-order (unscattered) target return beam retraces its path identically back to target beam splitter 48. If reference mirror 76 is placed at the focus of illumination lens 70, rather than passing reference beam 71 through an objective, such as reference objective 62 in system 40, then the beam reflected from reference mirror 76 also identically retraces its path back to beam splitter 72. Thus, the reflected reference beam forms the same wavefront that it would have if the reference objective was included in the reference arm. As illustrated in FIG. 3, reference mirror 76 may be a flat mirror. In another embodiment, reference mirror 76 may be a curved mirror placed a distance away from the waist of reference beam 71.

FIG. 4 illustrates a schematic view of a laser beam split into two orthogonally polarized beams. A laser, such as laser 12 as shown in FIGS. 1 and 2, may generate laser beam 80. In one embodiment, laser beam 80 may be linearly polarized (e.g., the angle of the beam electric-field is fixed). Laser beam 80 may be directed toward half-wave plate 82, which rotates laser beam 80 a half wavelength (e.g., approximately 180 degrees in phase). For example, half-wave plate 82 may rotate laser beam 80 from one-hundred percent (100%) s-polarization to one-hundred percent (100%) p-polarization. Half-wave plate 82 may operate to rotate laser beam 80 in order to obtain the desired polarization. The rotated beam may then be directed to beam splitter 84. In one embodiment, beam splitter 84 may be a polarizing beam splitter (PBS) that reflects light polarized in one direction and transmits light polarized in the opposite direction. Beam splitter 84 may further be a plate beam splitter or a cube beam splitter.

Beam splitter 84 may divide laser beam 80 into reference beam 87 and target beam 89 that respectively are directed into a reference arm and a target arm of a direct-to-digital holography system. In the illustrated embodiment, the reference arm may include reference half-wave plate 86 and the target arm may include target half-wave plate 88. Similar to half-wave plate 82, reference and target half-wave plates 86 and 88 may respectively rotate reference and target beams 87 and 89 a half wavelength. Half-wave plates 86 and 88 may be used to match the polarization in each arm to an acousto-optic modulator (AM), which typically requires polarization with a specific orientation to the sound-field.

In another embodiment, the reference and target arms may not include half-wave plates such that reference and target beams 87 and 89 are not rotated before being received by the respective reference and target optics. In this particular embodiment, the target arm may include a quarter wave-plate located at the target objective that rotates target beam 87 approximately ninety degrees (90°) in order to suppress back-reflections and the reference arm may have no reference objective and/or no quarter wave-plate such that reference beam 89 is not rotated. For example, s-polarization may be directed into the target arm and p-polarization may be directed into the reference arm. Target beam 87 passes through the quarter wave-plate before reaching the target and after being reflected from the target and is rotated to p-polarization. Since the reference arm was originally p-polarization and not rotated by a half wave-plate, both beams may have the same polarization at the beam combiner.

In general, power in the target and reference arms of a direct-to-direct holography system, such as system 40, should be substantially matched in order to acquire an image of an object, such as target 20. Half-wave plate 82 may rotate the polarization of laser beam 80 arbitrarily to select a desired polarization and split the power between the target and reference arms. Beam splitter 84 receives the rotated beam and sends s-polarized light into one arm (e.g., the target arm) and p-polarized light into another arm (e.g., the reference arm).

Small variations in angles or placement of components in the direct-to-digital holography system may cause the polarization to not be perfectly matched even though the power is divided between the target and reference arms. Reference and target half-wave plates 86 and 88 in each of the arms may allow for a substantially perfect match to the other polarizing components in each arm such that when the target and reference beams are received at a digital recorder, each of the beams has the same polarization. By adding or eliminating reference and target half-wave plates 86 and 88, the polarization of reference and target beams 87 and 89 may be matched to other polarization dependent components (e.g., acousto-optic modulators and other beam splitters) in each of the arms.

In one embodiment, target beam 87 may be composed of s-polarized light and reference beam 89 may be composed of p-polarized light. In order to match the polarization of target and reference beams 87 and 89, either target half-wave plate 86 or reference half-wave plate 88 may be rotated in order to match the polarizations of the two arms at the digital recorder. Once target and reference beams 87 and 89 have the same polarizations, a beam combiner, such as beam combiner 46 as shown in FIG. 2, located at the outputs of the two arms may combine the beams to form a complex image that may be captured by the digital recorder.

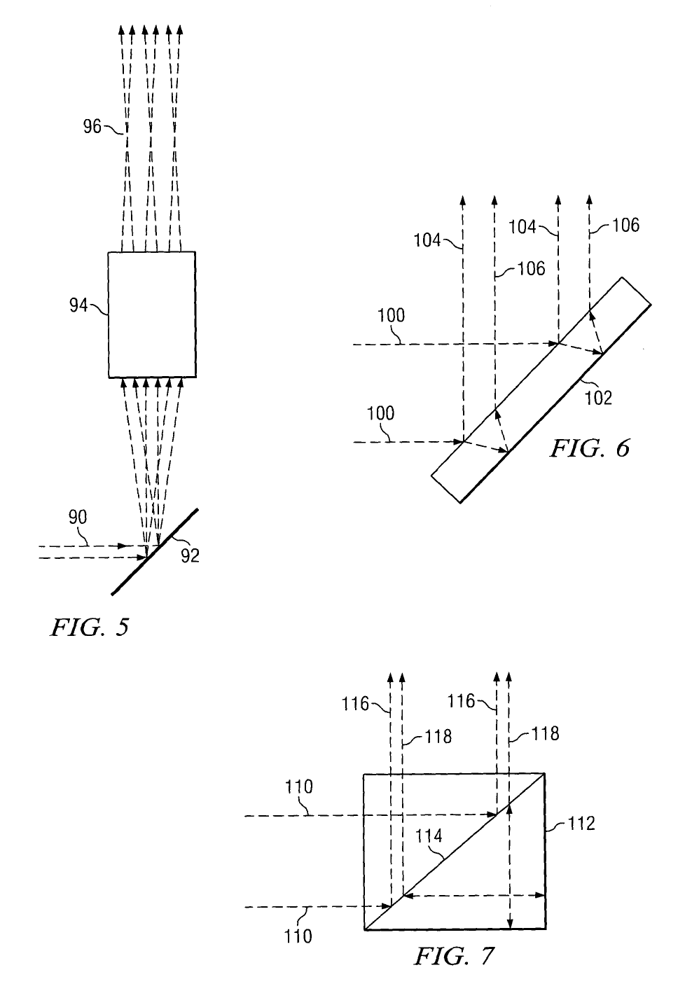

FIG. 5 illustrates a schematic view of a target arm included in a direct-to-digital holography system. In the illustrated embodiment, target beam 90 may be collimated by a collimating lens (not expressly shown) and directed toward tilting mirror 92. In one embodiment, tilting mirror 92 may be a gimbal mirror configured to rotate about the center of the mirror. In another embodiment, tilting mirror 92 may be any type of rotatable mirror that operates to vary the angle of target beam 90. Tilting mirror 92 may direct target beam 90 toward illumination lens 94 at different angles such that illumination lens 94 may capture off-axis portions of target beam 90. Illumination lens 94 operates to focus the off-axis portions of target beam 90 and directs the focused beam to a target objective, such as target objective 54 as shown in FIG. 2.

Generally, the resolution associated with a direct-to-digital holography system may be determined by the amount of higher frequency components included in an acquired image. These higher frequency components are typically located in the off-axis, rather than incident or on-axis, portions of the beam. For example, the on-axis portions of reference beam 90 may include the intensity or amplitude associated with the beam while the off-axis portions of reference beam 90 may include spatial information. In conventional systems, the off-axis portions may be lost because the illumination beam is directed such that the illumination lens captures only on-axis, incident light.

In order to perform off-axis illumination, target beam 90 may be laterally shifted at the back end of a target objective. In the illustrated embodiment, target beam 90 may be shifted by placing tilting mirror 92 at a back focal point of illumination lens 94. If reference beam 90 is nearly collimated at the back focal point, the effect of pivoting target beam 90 may be a shift of the beam after illumination lens 94. A spot on the target (not expressly shown) usually illuminated by the on-axis portions of target beam 90 may be illuminated by a beam directed at an angle from the edge of the aperture of the target arm objective, which allows off-axis illumination of the target when desired. Since the focused beam appears to be an off-axis beam, it may be focused by the target object to the center of its field-of-view at an off-axis angle.

In one embodiment, tilting mirror 92 may be rotated such that the angle of target beam 90 is changed. For example, tilting mirror 92 may be rotated a small amount in a clockwise direction to capture higher frequencies in one direction and then rotated a small amount in a counter-clockwise direction to capture higher frequencies in the opposite direction. A small change in the angle of tilting mirror 92 may create a large angle in target beam 90 at illumination lens 94. The rotation allows target beam 90 to have any desired off-axis angle and allows images with various frequency content to be captured and combined by digital manipulation in Fourier space after a Fast Fourier Transform. By capturing the higher frequencies, the resolution of the system may be improved since spatial information resides in the higher frequency components.

FIG. 6 illustrates a schematic view of a plate beam splitter. In the illustrated embodiment, beam 100 may be directed at plate beam splitter 102. In one embodiment, plate beam splitter 102 may be approximately ninety-nine percent (99%) reflective to light having one polarization and approximately ninety-five percent (95%) transmissive to light having the opposite polarization. In the illustrated embodiment, beam 100 may have a polarization such that at least a portion of beam 100 is reflected from an upper surface of plate beam splitter 102 to form reflected beam 104.

Beam 100 may also include a polarization such that at least a portion of beam 100 is transmitted through the upper surface. The transmitted portion of beam 100 may travel through plate beam splitter 102 and reflect from a lower surface to create ghost beam 106. Since ghost beam 106 may be created by a reflection from one surface of plate beam splitter 102, ghost beam 106 may also be referred to as a first order reflection. The first order reflection may be created because the upper and lower surfaces of beam splitter 102 are parallel.

In one embodiment, the lower surface may include an anti-reflective (AR) coating. Even though the back surface of plate beam splitter 102, the transmitted beam may reflect off of the lower surface to create ghost beam 106. In one embodiment, ghost beam 106 may have an intensity approximately equal to AR/2, where AR is the percentage of incident light reflected from the AR coating. Ghost beam 106 may have the same or opposite polarization as beam 104 and thus, create interference patterns in an image captured by a digital recorder. The interference patterns may cause unwanted lines and circles to form on an acquired image.

FIG. 7 illustrates a schematic view of a cube beam splitter used in a direct-to-digital holography system. In the illustrated embodiment, beam 110 may be directed at cube beam splitter 112. In one embodiment, cube beam splitter 112 may be a 50/50 beam splitter where approximately fifty percent (50%) of a beam is reflected and approximately fifty percent (50%) of the beam is transmitted. In another embodiment, cube beam splitter 112 may reflect and/or transmit any suitable percentage of beam 110. In a further embodiment, cube beam splitter 112 may be a cube beam combiner that combines at least two received beams.

Unlike plate beam splitter 102 as shown in FIG. 6, cube beam splitter 112 does not create first order reflection beams that may cause interference patterns in a complex image. As illustrated in FIG. 7, beam 110 may have a polarization such that a portion of the beam is reflected by plate 114 and a portion of the beam is transmitted by plate 114. Reflected beam 116 may represent the desired portion of beam 110 to be directed toward a digital recorder. The transmitted portion of beam 110 may be reflected from one side of cube beam splitter 112, reflected off of plate 114 and reflected off of a second side of cube beam splitter 112 to form ghost beam 118. Since ghost beam 118 may be reflected off of at least two surfaces of cube beam splitter 112, ghost beam 118 may also be referred to as a second order reflection. In one embodiment, all sides of cube beam splitter 112 may include AR coating. Since ghost beam 118 is a second order reflection, ghost beam 118 is at least three orders of magnitude lower than ghost beam 106 created by plate beam splitter 102 because the portion of the beam transmitted by plate 114 had to reflect from two of the sides of cube beam splitter 112 before being transmitted in the same direction as reflected beam 116. For example, the percentage of the transmitted beam that forms ghost beam 118 and is eventually directed in the same direction as reflected beam 116 may be described by AR² where AR is the percentage of light reflected from the AR coating.

Although components illustrated in FIGS. 3 through 7 have been described separate from systems 10 and 40 as respectively shown in FIGS. 1 and 2, any of these components, individually or as a group, may be substituted for like components in systems 10 and 40. Additionally, although the present invention has been described with respect to a specific preferred embodiment thereof, various changes and modifications may be suggested to one skilled in the art and it is intended that the present invention encompass such changes and modifications fall within the scope of the appended claims.

What is claimed is:

1. A direct-to-digital holography system, comprising:
an illumination lens operable to focus a reference beam;
a beam splitter optically coupled to the illumination lens by the reference beam; and
a reference mirror located at a waist of the reference beam, the reference beam mirror operable to eliminate a reference objective.

2. The system of claim 1, wherein the beam splitter comprises a cube beam splitter operable to eliminate first order reflections.

3. The system of claim 1, further comprising a quarter-wave plate optically coupled between the beam splitter and the reference mirror.

4. The system of claim 1, wherein the reference beam comprises a Gaussian beam.

5. The system of claim 1, wherein the reference mirror comprises a flat mirror.

6. The system of claim 1, further comprising the reference mirror operable to maintain optical symmetry of a reference arm and a target arm.

7. The system of claim 1, further comprising the reference mirror operable to form a first wavefront substantially similar to a second wavefront formed by the reference objective.

8. A method for acquiring a complex image in a direct-to-digital holography system, comprising:
focusing a reference beam with an illumination lens, the reference beam including a waist;
transmitting at least a portion of the reference beam through a beam splitter; and
reflecting the portion of the reference beam from a reference mirror located at the waist of the reference beam.

9. The method of claim 8, further comprising the reference mirror operable to replace a reference objective.

10. The method of claim 9, further comprising forming a combined wavefront at a digital recorder, the wavefront substantially similar to a wavefront produced by the reference objective.

11. The method of claim 8, further comprising the reference mirror operable to maintain optical symmetry of a reference arm and a target arm.

12. The method of claim 8, wherein the reference beam comprises a Gaussian beam.

13. A direct-to-digital holography system, comprising:
a laser operable to produce a laser beam;
a half-wave plate optically coupled to the laser, the half-wave plate operable to rotate the laser beam between a first polarization and a second polarization;
a beam splitter located proximate the half-wave plate, the beam splitter operable to split the laser beam into a reference beam associated with a reference arm and a target beam associated with a target arm such that the reference beam includes the first polarization and the target beam includes the second polarization;
a target half-wave plate optically coupled to the beam splitter by the target beam; and
a reference half-wave plate optically coupled to the beam splitter by the reference beam;
the target and reference half-wave plates operable to respectively rotate the target and reference beams in order to match polarizations of the target and reference arms.

14. The system of claim 1, wherein the beam splitter comprises a cube beam splitter operable to eliminate first order reflections.

15. The system of claim 1, wherein the laser beam comprises a linearly polarized beam.

16. The system of claim 1, further comprising the target and reference half-wave plates operable to respectively rotate the target and reference beams to match power in the target and reference arms.

17. The system of claim 13, further comprising a beam combiner optically coupled to outputs of the target and reference arms, the beam combiner operable to combine the rotated target and reference beams to generate a complex image.

18. A method for acquiring a complex image in a direct-to-digital holography system, comprising:
rotating a laser beam such that the laser beam includes either a first polarization or a second polarization;
splitting the rotated beam into a target beam associated with a target arm and a reference beam associated with a reference arm, the target beam including the first polarization and the reference beam including the second polarization; and
rotating either the target beam or the reference beam in order to obtain either the first polarization or the second polarization at beam combiner located proximate outputs of the target and reference arms.

19. The method of claim 18, further comprising matching power in the target and reference arms.

20. The method of claim 18, further comprising the beam combiner operable to combine the rotated reference and target beams at a digital recorder in order to create a complex image.

21. A direct-to-digital holography system, comprising:
a laser operable to generate a laser beam;
a lens operable to focus the laser beam; and
a tilting mirror optically coupled between the laser and the lens at a back focus point of the lens, the tilting mirror operable to pivot in order to reflect the laser beam towards the lens at an off-axis angle.

22. The system of claim 21, wherein the laser beam comprises a substantially collimated beam.

23. The system of claim 21, wherein the tilting mirror comprises a gimbal mirror.

24. The system of claim 21, further comprising an objective optically coupled to the lens by the laser beam, the objective operable to illuminate a target with the off-axis angle laser beam.

25. The system of claim 21, further comprising the tilting mirror operable to increase a resolution of a complex image acquired by the system.

26. A method for acquiring a complex image in a direct-to-digital holography system, comprising:
reflecting a laser beam from a tilting mirror located at a back focal point of an illumination lens, the tilting mirror operable to pivot about a center in order to create an off-axis laser beam;
passing the off-axis laser beam through the illumination lens; and
illuminating a target with the off-axis laser beam in order to generate an image including high frequency components.

27. The method of claim 26, wherein the laser beam comprises a substantially collimated beam.

28. The method of claim 26, wherein the tilting mirror comprises a gimbal mirror.

29. A direct-to-digital holography system, comprising:
a laser operable to generate a laser beam; and
a cube beam splitter optically coupled to the laser, the cube beam splitter operable to eliminate first order reflections.

30. The system of claim 29, wherein the cube beam splitter comprises at least four sides including an anti-reflective coating.

31. The system of claim 29, further comprising a ghost beam generated if a transmitted portion of the laser beam reflects off at least two sides of the cube beam splitter, the ghost beam including a second order reflection.

32. The system of claim 29, further comprising the cube beam splitter operable to reduce interference patterns in a complex image captured by a digital recorder.
